(19) United States
(12) Patent Application Publication
(10) Pub. No.: US 2015/0213510 A1
(43) Pub. Date: Jul. 30, 2015

(54) FRAMEWORK THAT FACILITATES USER PARTICIPATION IN AUCTIONS FOR DISPLAY ADVERTISEMENTS

(71) Applicant: Microsoft Corporation, Redmond, WA (US)

(72) Inventors: Justin Rao, New York, NY (US); Sebastien Lahaie, Greenwich, CT (US); David Pennock, Princeton, NJ (US); John Langford, Scarsdale, NY (US); Ruggiero Cavallo, Brooklyn, NY (US)

(73) Assignee: Microsoft Corporation, Redmond, WA (US)

(21) Appl. No.: 14/166,783

(22) Filed: Jan. 28, 2014

(51) Int. Cl. G06Q 30/02

(52) U.S. Cl. CPC G06Q 30/0275

(57) ABSTRACT

Various technologies relating to prevention of display of advertisements on pages rendered on client computing devices are described. A user participates in real-time auctions for advertisement positions on pages, where a bidding agent submits bids on behalf of the user. When the user wins an auction for an advertisement position, the advertisement position is populated with content approved by the user, thus effectively preventing another advertiser from presenting an advertisement in the advertisement position.

### BACKGROUND

Advertising is used to monetize various web-based services and content, wherein exemplary web-based services include social networking websites, news websites, video games, e-mail applications, messaging applications, etc., and exemplary content includes blog entries written by blog writers, news articles, video games, etc. Conventionally, an advertisement exchange is notified when a client computing device (e.g., of a particular user) requests a page belonging to a particular website. The advertisement exchange, responsive to being notified that the client computing device has requested the page, executes an auction for an advertisement position on the page. Generally, advertisers submit respective bids to have their advertisements displayed on the page, and the advertiser that submits the bid with the highest value is deemed the winner of the auction for the advertisement position. The advertisement of the advertiser is then displayed in the advertisement position in the page on a display of the client computing device, such that the user of the device is exposed to the advertisement. While being inundated with advertisements (particularly those not relevant to interests of the user) may be harmful to user experience, display advertising is oftentimes necessary to create a revenue stream for the provider of the service and/or content.

With respect to web browsers, ad blockers (installed as browser add-ins) have been developed to block advertisements. For example, the ad blocker can search for a particular domain in redirects transmitted to the web browser, and can prevent the web browser from loading content of redirects that include the particular domain. With more particularity, when a web browser is directed to load a page that comprises an advertisement position that can be populated by an advertisement, an advertisement exchange is notified and conducts an auction for the advertisement position. Responsive to the advertisement exchange determining the winner of the auction, the advertisement exchange provides the web browser with a redirect that includes a uniform resource identifier (URI) that identifies the location of the advertisement of the auction winner, wherein the URI includes a particular domain (e.g., a domain associated with the advertisement exchange). The ad blocker intercepts the redirect and searches the URI for the particular domain, and when the ad blocker identifies that the URI in the redirect includes the particular domain, prevents the web browser from retrieving the advertisement. The web page, when rendered by the browser on a display, thus does not include the advertisement, but may instead include aesthetically displeasing graphics (e.g., empty boxes that indicate that particular content was unable to be loaded by the web browser). Accordingly, while the ad blocker may prevent certain advertisements from being presented to the user, the rendered webpage may nevertheless be aesthetically unappealing.

Still further, ad blockers effectively prevent publishers and service providers from receiving the revenue typically generated through web-based display advertising. That is, when the ad blocker prevents the web browser from retrieving an advertisement, a content provider or publisher receives no revenue. Moreover, ad blockers are typically imperfect, and it can be unpredictable as to which advertisements will be and will not be blocked by the ad blocker.

### SUMMARY

The following is a brief summary of subject matter that is described in greater detail herein. This summary is not intended to be limiting as to the scope of the claims.

Described herein are various technologies pertaining to user-participation in auctions for advertisement positions on pages (e.g. web pages, pages generated by an application executing on a client computing device, such as a social networking application, etc.). In an exemplary embodiment, technologies related to a computer-executable bidding agent that submits bids on behalf of a user are set forth herein, wherein the bids are for respective advertisement positions on pages that are to be displayed on a display of a client computing device employed by the user. Also described herein are various technologies pertaining to executing an auction for an advertisement position on a page to be displayed on a display of a client computing device, wherein the aforementioned computer-executable agent submits a bid on behalf of the user, and the auction is executed based upon such bid. Additionally described herein are various technologies pertaining to the display of user-selected content in an advertisement position when the user wins an auction for the advertisement position.

In an exemplary embodiment, a user can set forth an indication that she desires to participate in auctions for advertisement positions on pages rendered at client computing devices of the user, wherein when the user wins the auction an advertisement is effectively prevented from being presented to the user (thus enhancing user experience on pages displayed to the user). For example, the user can have an account that includes units of value (e.g., monetary value), and may set forth an indication of bid values and/or a budget that is to be used to bid on advertisement positions. For example, the budget may be an amount of money over a predefined period of time (e.g., $20 for one year). The bid values can specify bid amounts for advertisement positions shown on respective pages.

A graphical user interface (GUI) can be provided to the user that is configured to receive the budget and/or bid values, thus facilitating prevention of display of advertisements on pages rendered on client computing devices of the user. For example, the user can identify particular categories of pages (e.g., news, social networking, e-mail, blog, etc.) upon which advertisements are desirably prevented from being displayed. In yet another example, the GUI can facilitate receipt of identifications of particular domains, wherein the user desires that advertisements are prevented from being displayed on pages of the identified domains. Additionally, historic user behavior can be received (e.g., historic browsing behavior of the user), which can be employed to program the computer-executable bidding agent, as well as to provide information to the user when the user is setting forth budget and/or bid data via the GUI. For example, the user may indicate that she wishes to spend $20 on ad prevention over the next year, and based upon her browsing history, the GUI can set forth an estimate that some percentage (e.g., 80%) of advertisements will be blocked over the next year based upon the budget set forth by the user. As the user provides more granular information about how she wishes to block advertisements (e.g., identifications of domains, web pages, etc.), more granular information about ad prevention estimates can be provided by way of the GUI.

In an exemplary embodiment, based upon the data received from the GUI, a computer-executable bidding agent for the user can be constructed, wherein the bidding agent is programmed to set forth bids in auctions for advertisement positions on behalf of the user. The bidding agent may be “intelligent,” in that the bidding agent considers several factors when determining a bid value in an auction for the advertisement position, wherein the factors can include amount of user budget remaining, user browsing patterns, historic winning bids for a domain, etc. In another example, the bidding agent can be configured to bid a predefined amount (e.g., for advertisement auctions for a particular domain), where the predefined amount is user-specified.

The computer-executable agent can be associated with a demand side platform (DSP) account of the user, such that the user need not have accounts with multiple advertisement exchanges to participate in auctions conducted by different advertisement exchanges. Specifically, numerous different advertisement exchanges exist, and conventionally, an advertiser wishing to set forth bids in auctions for advertisement positions must have a respective account with each advertisement exchange. The DSP allows the user to have a single account, but participate in auctions run by numerous different advertisement exchanges.

Subsequent to the user bidding agent being constructed, the user bidding agent can set forth bids on behalf of the user in auctions for advertisement positions on pages that are to be displayed on client computing devices of the user. In an example, the user may employ an application (e.g., a web browser) on a computing device, and can direct the application to request a particular page (e.g., a web page of a news domain) hosted on a web server. The web server, responsive to receiving the request, transmits a redirect to the application on the client computing device, wherein the redirect identifies an advertisement server (e.g., operated by an advertisement exchange) that is to conduct an auction for an advertisement position on the web page. The application, responsive to receiving the redirect, transmits data to the advertisement server that indicates that an auction for an advertisement position is to be performed.

The advertisement server receives the data from the application executing on the client computing device, and responsive to receipt of the data, conducts an auction for the advertisement position. With more detail, the advertisement server solicits bids from a respective plurality of bidders based upon, for example, content of the web page, data about the user, or the like. The advertisement server then receives a plurality of bids for the advertisement position, wherein the plurality of bids have a respective plurality of values. One of such bids can be generated by the user bidding agent, which sets forth the bid on behalf of the user. The advertisement server can then identify a winner of the auction based upon the plurality of bid values, wherein the bid having the highest bid value is the winning bid. When an advertiser is the winner of the auction, an advertisement of the advertiser is displayed in the advertisement position on the page at the client computing device (e.g., the advertisement server directs the application on the client computing device to retrieve an advertisement specified by the advertiser). When the user is the winner of the auction for the advertisement position (e.g., the bid value of the bid submitted on behalf of the user by the user bidding agent is the highest bid value), the advertisement server transmits a redirect to the application executing on the client computing device, wherein the redirect directs the application to content that has been approved by the user. For example, such content may be a one by one pixel window. In another example, the content may be a blank space with a color matching the background color of the page displayed on the client computing device. In yet another example, the content can be an image approved by the user (e.g., an image of a family member of the user, an image of current weather conditions, etc.).

The advertisement server can further be configured to assess a charge to the winner of the auction for the advertisement position. When the user is the winner of the auction, the advertisement server can assess a charge to the account of the user, wherein the charge is based upon at least one bid value of a bid submitted by another participant in the auction. For example, a second price auction mechanism can be used when assessing the charge to the account of the user. When an advertiser is the winner of the auction (e.g., the bid set forth by the advertiser has the highest value from amongst the bid values), the advertiser may be assessed a charge that is based upon the bid value of the bid set forth by the user bidding agent.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates an exemplary system that facilitates user participation in auctions for advertisement positions.

FIG. 2 is an exemplary page that comprises a plurality of advertisement positions.

FIG. 3 illustrates the exemplary page with the advertisement positions populated by a one by one pixel window.

FIG. 4 illustrates an exemplary page that comprises an advertisement position.

FIG. 5 illustrates the exemplary page with the advertisement position populated by a one by one pixel.

FIG. 6 illustrates an exemplary page comprising a plurality of advertisement positions.

FIG. 7 illustrates the exemplary page with the advertisement positions populated by blank spaces with colors matching the background color of the page.

FIG. 8 illustrates an exemplary system that facilitates constructing a computer executable agent that can set forth bids in auctions for advertisement positions on behalf of a user.

FIG. 9 is a communications diagram illustrating communications undertaken between various entities when a page is displayed on a display of a client computing device of a user.

FIG. 10 is a communications diagram illustrating communications undertaken between a client computing device and a server that hosts a demand side platform (DSP) when constructing a computer-executable bidding agent for the user.

FIG. 11 is an exemplary graphical user interface that can be presented to a user in connection with constructing a computer-executable bidding agent for the user.

FIG. 12 is another exemplary graphical user interface that can be presented to a user in connection with constructing a computer-executable bidding agent for the user.

FIG. 13 is a flow diagram that illustrates an exemplary methodology for executing an auction for an advertisement position on a page to be displayed on a client computing device.

FIG. 14 is a flow diagram illustrating an exemplary methodology for displaying user-approved content in an advertisement position on a webpage responsive to determining that the user has won an auction for the advertisement position.

FIG. 15 is a flow diagram illustrating an exemplary methodology for constructing a computer executable bidding agent that sets forth bids in auctions for advertisement positions on behalf of the user.

FIG. 16 is an exemplary computing system.

### DETAILED DESCRIPTION

Various technologies pertaining to user-participation in auctions for advertisement positions are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by a single system component may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

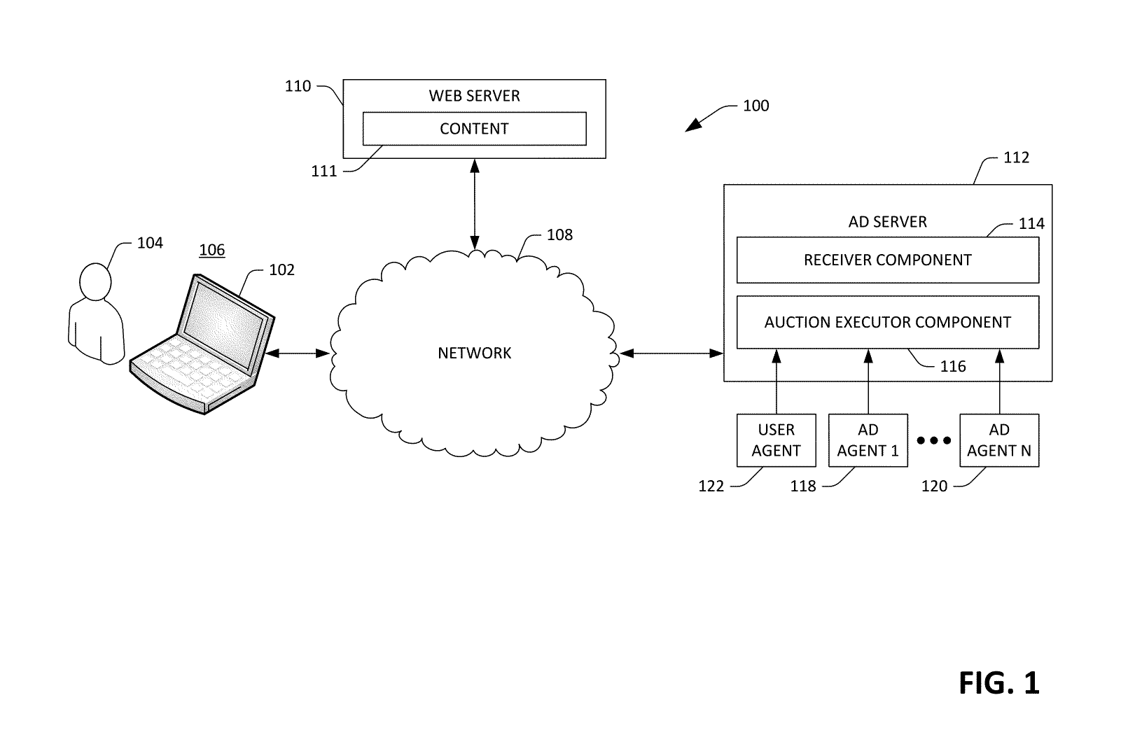

With reference now to FIG. 1, an exemplary system 100 that facilitates prevention of advertisements from being presented to a user is illustrated. The system 100 includes a client computing device 102 being employed by a user 104, wherein the client computing device 102 has a display 106 associated therewith. Accordingly, the client computing device 102 may be any suitable client computing device including, but not limited to, a desktop computing device, a mobile computing device (such as a laptop computing device, a mobile phone, a tablet computing device, a convertible computing device), a television, a video game console, or the like. The client computing device 102 has an application executing thereon, such as a web browser, a social networking application, a news application, an e-mail application, a weather application, or any other suitable application that is configured to render pages on the display 106 of the client computing device 102, wherein at least some content of the pages is retrieved by way of a network 108 (such as the Internet).

The system 100 additionally includes a web server 110 that is in communication with the client computing device 102 by way of the network 108. The web server 110 hosts content 111 that can be displayed on the display 106 of the client computing device 102. In an exemplary embodiment, when the application executing on the client computing device 102 is a web browser, the content 111 can be a web page that is hosted by the web server 110. When the application executing on the client computing device 102 is an application other than a web browser (such as a social networking application, a videogame application, or the like), the content 111 can be pages (images, arrangements of graphical data, etc.) that can be displayed on the display 106 of the client computing device 102 by the application executing thereon.

Pursuant to an example, the application executing on the client computing device 102 may be directed to retrieve the content 111 for display on the display 106 of the client computing device 102, resulting in presentment of a page on the display 106. The page can include an advertisement position (or multiple advertisement positions), wherein when the page is displayed on the display 106 of the client computing device 102, the advertisement position on the page can be populated by an advertisement. Exemplary advertisements that can be included in the advertisement position include banner advertisements, rectangular units, or the like.

The system 100 additionally includes an ad server 112 that is in communication with the client computing device 102 and/or the web server 110 by way of the network 108. Generally, the owner of the content 111 hosted at the web server 110 enters into a contractual agreement with an advertisement exchange that maintains the ad server 112, where the advertisement exchange is configured to match advertisement positions on pages of the owner of the content 111 with advertisers that wish to present advertisements in the advertisement positions. The advertisement exchange thus acts as a broker between the owner of the content 111 and advertisers. The function of the ad server 112, then, is to sell the advertisement position on the page displayed on the display 106 of the client computing device 102 to an advertiser, thereby providing a source of revenue for the owner of the content 111 hosted on the web server 110. To that end, responsive to the application executing on the client computing device 102 requesting the content 111 from the web server 110, the ad server 112 receives an indication that 1) the page is to be displayed on the display 106 of the client computing device 102; and 2) that the page includes an advertisement position. In an exemplary embodiment, the web server 112 receives a request for the content 111 from the application on the client computing device 102, and transmits a redirect to the client computing device 102 responsive to receiving the request. The redirect points to the ad server 112, such that the application on the client computing device is caused to transmit the indication to the ad server 112, wherein the indication can include data that is indicative of the content 111 to be included on the page, data that identifies a domain of the page, data that identifies browsing patterns of the user of the client computing device (e.g., a cookie), etc.

A receiver component 114 of the ad server 112 receives such indication. While the indication has been described as being received from the client computing device 102, it is to be understood that the indication can be received from another computing device, such as the web server 110. The ad server 112 further includes an auction executor component 116 that, responsive to the receiver component 114 receiving the indication mentioned above, conducts an auction for the advertisement position on the page. In conducting the auction, the auction executor component 116 solicits bids from a plurality of prospective bidders. In an exemplary embodiment, advertisers can define bidding criteria and expose such a bidding criteria to the ad server 112. When data in the indication noted above meets such criteria for a particular advertiser, the advertiser can set forth a bid for the advertisement position(s) on the page. Exemplary criteria set forth by advertiser can include, but is not limited to, content of the page (e.g., the advertiser may sell goods or services related to the content of the page), demographic information about the user (e.g., the advertiser may wish to advertise two people having a particular gender and age combination), browsing history of the user 104 (e.g., the advertiser may wish to advertise when the user 104 recently viewed content related to a good or service being sold by the advertiser), or the like.

Therefore, responsive to the receiver component 114 receiving the indication that the page is to be displayed on the display 106 of the client computing device 102, and optionally other information about the user 104 and/or browsing history of the user 104, the auction executor component 116 can solicit bids from advertisers based upon the indication. As shown in FIG. 1, the auction executor component 116 can solicit bids from a plurality of ad agents 118-120 that represent respective advertisers. For instance, ad agents 118-120 are configured to set forth bids having respective bid values for display in the advertisement position on the page. The respective values of bids set forth by the ad agents 118-120 can depend upon defined budgets set forth by advertisers represented by the ad agents 118-120, content of the page to be displayed on the display 106 of the client computing device 102, attributes of the user 104, amongst other data. While in FIG. 1 the ad agents 118-120 have been described as submitting bids based upon multiple criteria, it is to be understood that an advertiser may set forth a standing bid (e.g., for a particular domain), and the term “ad agent” is intended to encompass standing bids.

In contrast to conventional approaches, the auction executor component 116 can also receive a bid for the advertisement position from a user bidding agent (user agent) 122 that is configured to set forth bids on behalf of the user 104. Accordingly, when the receiver compound 114 receives the indication that the page is to be displayed on the display 106 of the client computing device 102, the auction executor component 116 can receive a plurality of bids having a respective plurality of bid values for the advertisement position on the page, wherein one of such bids is set forth by the user agent 122 on behalf of the user 104 (who will be viewing the page on the display 106).

Responsive to receiving the plurality of bids from the ad agents 118-120 and the user agent 122, the auction executor component 116 identifies a winner of the auction for the advertisement position based upon the respective values of the received bids (e.g., the winner is the bidder who submitted the bid with the highest bid value). When the user 104 wins the auction for the advertisement position (e.g., the bid value set forth by the user agent 122 was the highest bid value), content approved by the user 104 is displayed in the advertisement position on the page. For example, when the user 104 wins the auction for the advertisement position on the page, the ad server 112 can transmit a redirect to the client computing device 102, wherein the redirect directs the application that renders the page to retrieve content approved by the user 104 for inclusion in the advertisement position on the page. In an example, for pages having a dynamic layout, the user 104 may indicate that a one by one pixel window is to be included in the advertisement position, thereby allowing for more content to be displayed on the page to the user 104. In another example, the user 104 may specify (e.g., by way of the user agent 122) that a photograph of a family of the user 104 is to be displayed in advertisement positions when the user 104 wins auctions for respective advertisement positions. In still yet another example, the user 104 can specify an application or content that is to populate the advertisement position. For instance, the user 104 may indicate that current weather conditions or stock market prices retrieved from those types of applications be shown in the advertisement position.

While not shown, it is to be understood that the user 104 has an account that includes units of value (e.g., money). When the user 104 wins the auction for the advertisement position (e.g., the bid submitted by the user agent 112 has the highest bid value from amongst bid values of bids submitted by all bidders), the ad server 112 can be configured to assess a charge to the account of the user 104. The charge assessed to the account of the user can be based upon at least one other bid submitted by one of the ad agents 118-120. For instance, the ad server 112 may employ a second-price auction mechanism to determine a charge to assess to the account of the user 104 (e.g., the account of the user 104 is charged based upon the second-highest bid value).

When an advertiser represented by one of the advertisement agents 118-120 wins the auction, the ad server 112 causes an advertisement of the advertiser to be presented in the page on the display 106 of the client computing device 102. That is, the redirect transmitted by the ad server 112 to the client computing device 102 directs the application executing on the client computing device 102 to retrieve the advertisement and render the advertisement on the page. When the advertiser wins the auction, in an exemplary embodiment, the auction executor component 116 can assess a charge to the advertiser based upon the bid value of the bid set forth by the user agent 122 on behalf of the user 104.

There are various advantages associated with the “bid to block” approach described above, where the user agent 122 sets forth bids for advertisement positions on behalf of the user. For example, auctions for advertisement positions to be presented on respective pages are typically won by bids with relatively small bid values (often less than 1/10 of one cent). Accordingly, from the perspective of the user 104, the user 104 can set aside a relatively small amount of money to effectively prevent a relatively large number of advertisements from being presented to the user 104, thereby improving satisfaction of the user 104 with respect to content presented to the user 104. Moreover, when the user 104 is out-bid, advertisements displayed to the user 104 are likely to be better targeted to interests of the user 104 and from “higher” quality advertisers, which can further improve user experience. With respect to the owner of the content 111 hosted at the web server 110, such owner retains, and most likely increases, the revenue generated based upon the content 111. Increased revenue is acquired due to the auction including another participant. This is in contrast to conventional ad blockers, which act to prevent the owner of the content 111 hosted at the web server 110 from generating ad-based revenue. The ad exchange is likewise benefited, as ad exchanges are typically compensated based upon some percentage of the charge assessed to the winner of the auction. Introducing another bidder to auctions for advertisement positions thus increases revenue of the ad exchange.

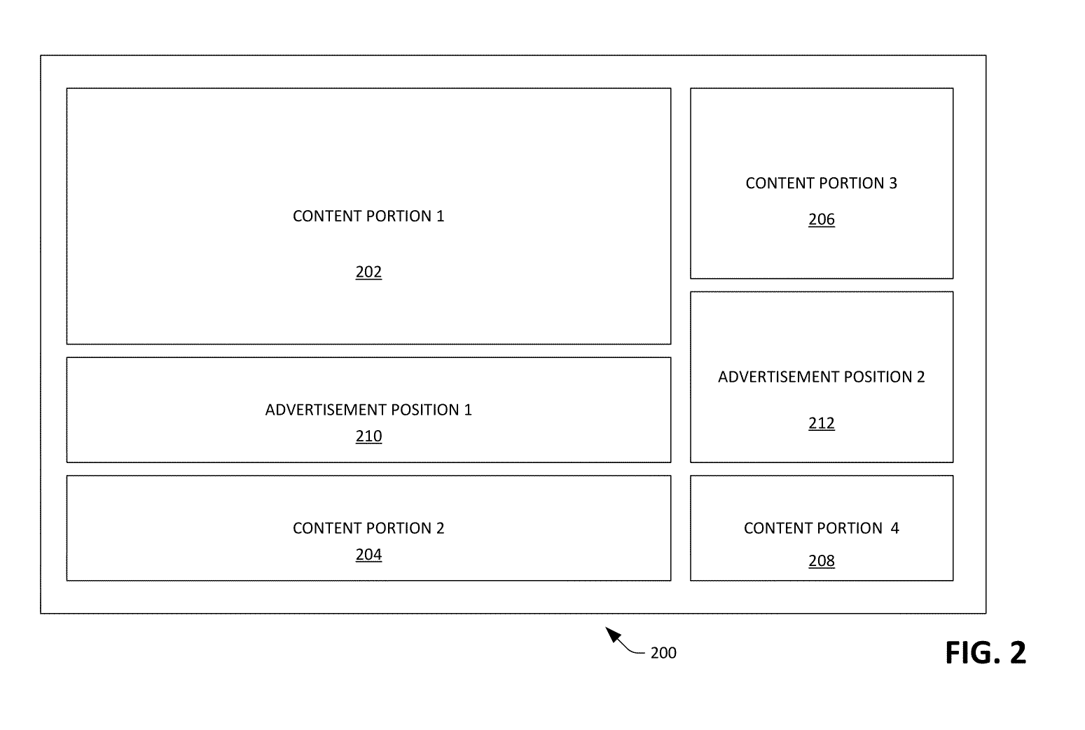

With reference now to FIG. 2, an exemplary page 200 that can be displayed on the display 106 of the client computing device 102 is illustrated. As indicated above, the page 200 may be a web page, such as a web page of a social networking site, a web page of the news site, a web page of a blog site, etc. In another example, the page 200 can be loaded by an application other than a browser on the client computing device 102, wherein content therein is retrieved from the Internet. Thus, for example, the page 200 may represent a frame of a video game, a page for presentment of a video to the user 104, etc. In the example shown in FIG. 2, the page 200 includes a plurality of content portions 202-208. Such content portions, when displayed on the display 106, are populated by the content 111 hosted on the web server 110. The page 200 further includes a plurality of advertisement positions 210-212. As indicated above, the ad server 112 is provided with an indication that the page 200 is to be displayed on the display 106 of the client computing device 102, and executes respective auctions for the advertisement positions 210-212. In an exemplary embodiment, the page 200 has a dynamic layout, such that the application executing on the client computing device 102 lays out the content portions 202-208 of the page 200 dynamically based upon, for example, display screen real estate on the display 106, type of client computing device 102, etc.

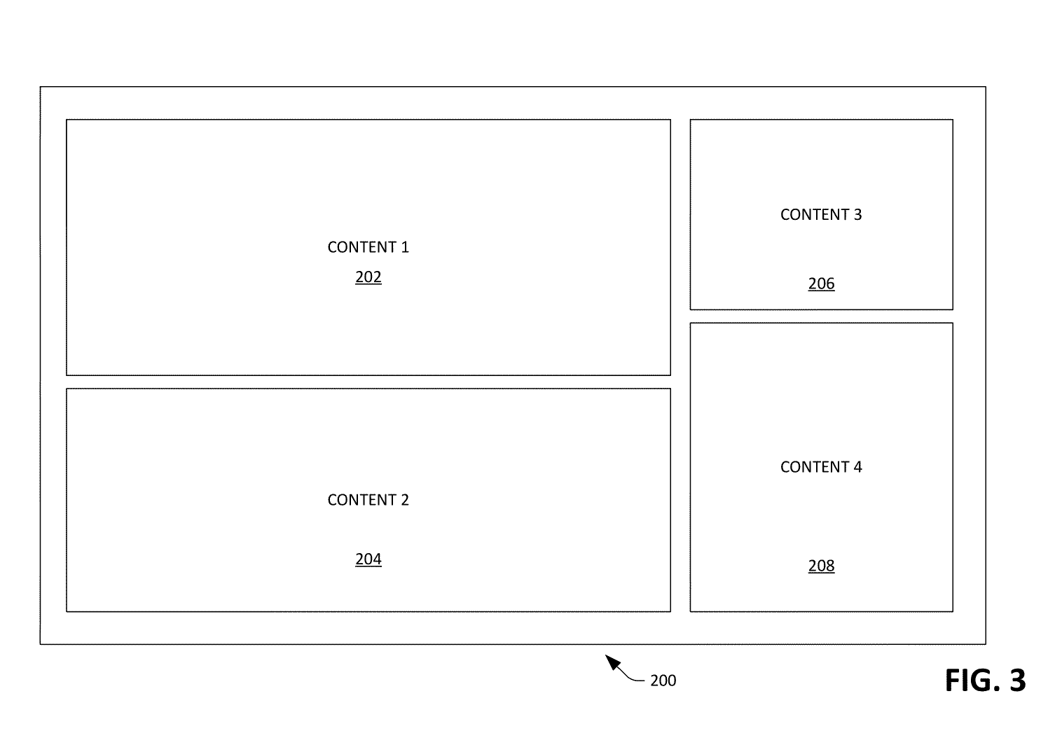

With reference to FIG. 3, the page 200 as displayed on the display 106 of the client computing device 102 when the user 104 wins the auctions for the advertisement positions 210-212 is illustrated. In this example, the content approved by the user 104 for display in the advertisement positions 210-212 is a one by one pixel window. When the application rendering the page retrieves the one by one pixel window and includes such pixel window in the advertisement positions 210-212, additional page real estate is made available for the content 111. For example, as the page 200 is one with a dynamic layout, one or more of the content portions 202-208 is expanded, thus providing the user 104 with additional content (which may be of interest to the user) on the page 200.

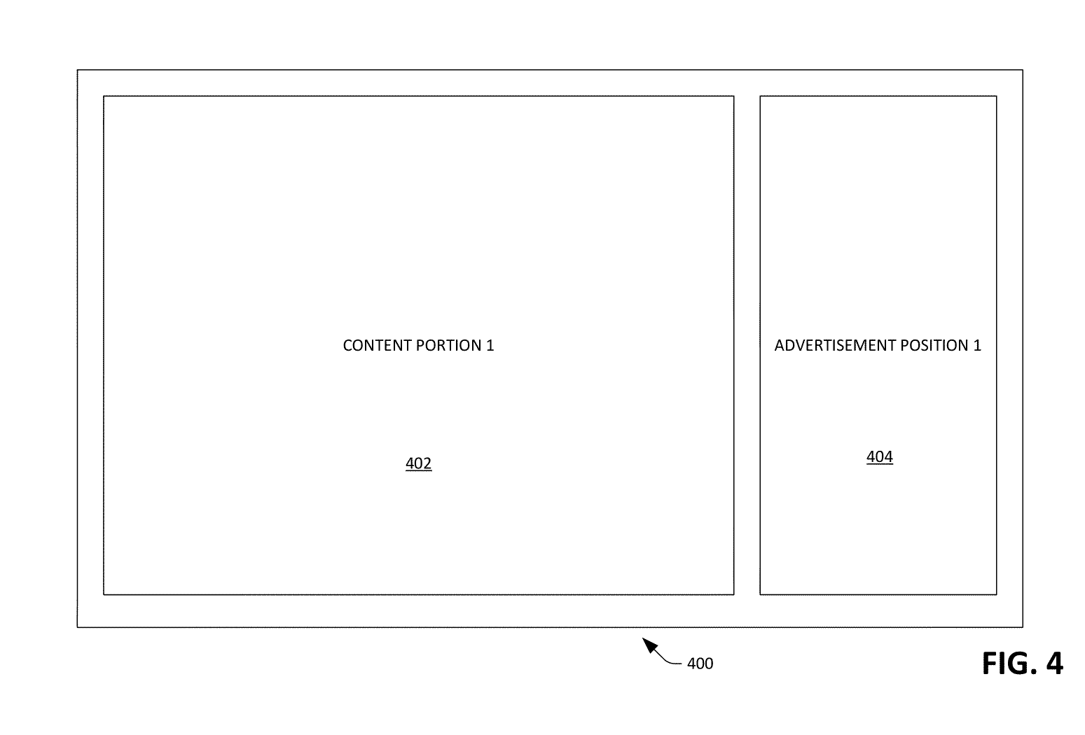

Now referring to FIG. 4, another exemplary page 400 is depicted. Again, the application executing on the client computing device 102 requests the content 111 hosted on the web server 112 and is configured to render the page 400 on the display 106 of the client computing device 102, wherein the page 400 includes a content portion 402 and an advertisement position 404. Responsive to the client computing device 102 requesting the content 111 from the web server 110, the ad server 112 is notified and the auction executor component 116 executes an auction for the advertisement position 404. Again, for example, the page 400 may be one with a dynamic layout.

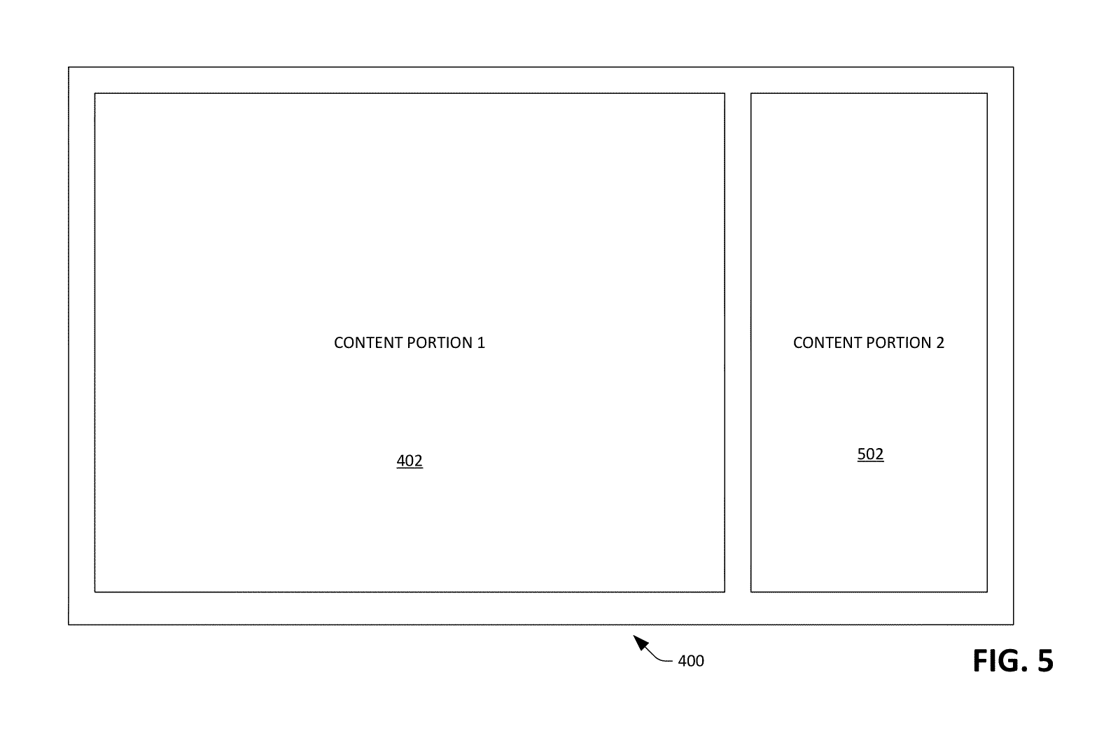

Now referring to FIG. 5, the page 400 as displayed on the display 106 of the client computing device 102 when the user 104 wins the auction for the advertisement position 404 is illustrated. In this example, the user 104 has approved that a one by one pixel window populate the advertisement position 404, thereby creating additional real estate on the page for additional content. Specifically, as the page 400 has a dynamic layout, an additional content portion 502 can be presented on the page 400 in the additional space created by populating the advertisement position 404 with the single pixel. For instance, when the page 400 is a news page, the first content portion 402 can include contents that that are representative of a first news story, while the second content portion 502 may include contents that are representative of a second news story.

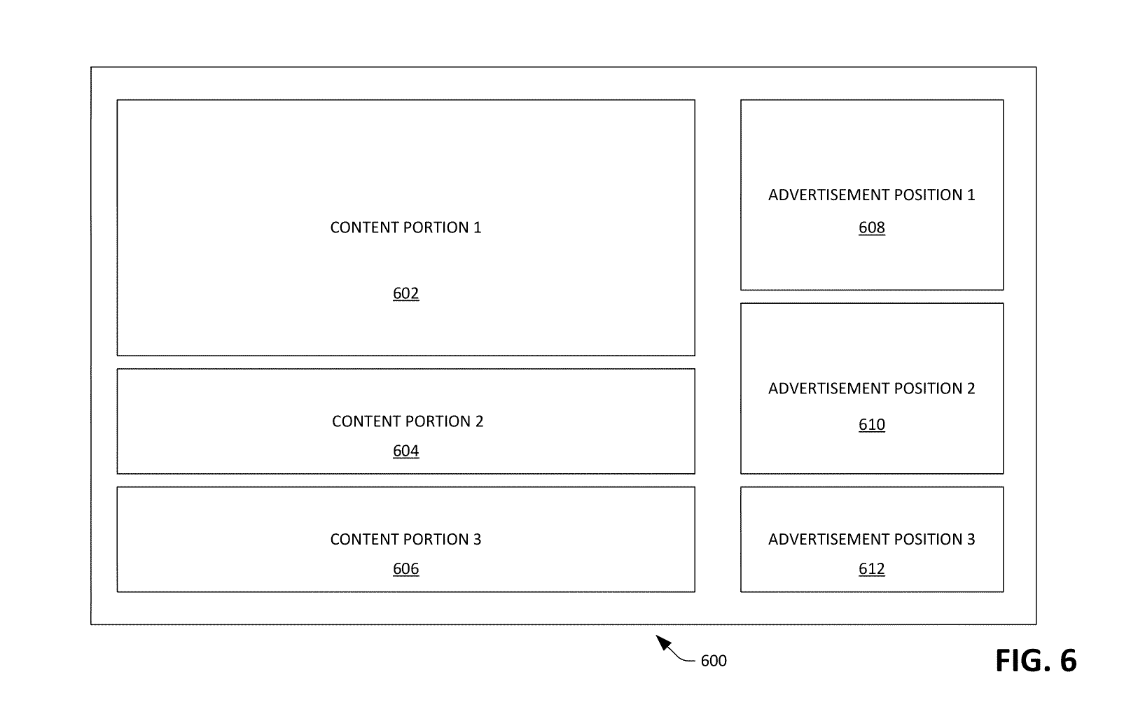

Now referring to FIG. 6, another exemplary page 600 requested for display on the client computing device 102 is illustrated, wherein the page 600 may have a fixed layout. The page 600 includes a plurality of content portions 602-606 and a plurality of advertisement positions 608-612. In an exemplary embodiment, the page 600 may be a page of a social networking website, wherein the content portions 602-606 are posts of contacts of the user 104 and the advertisement positions 608-612 are positioned in a side-bar of the page 600.

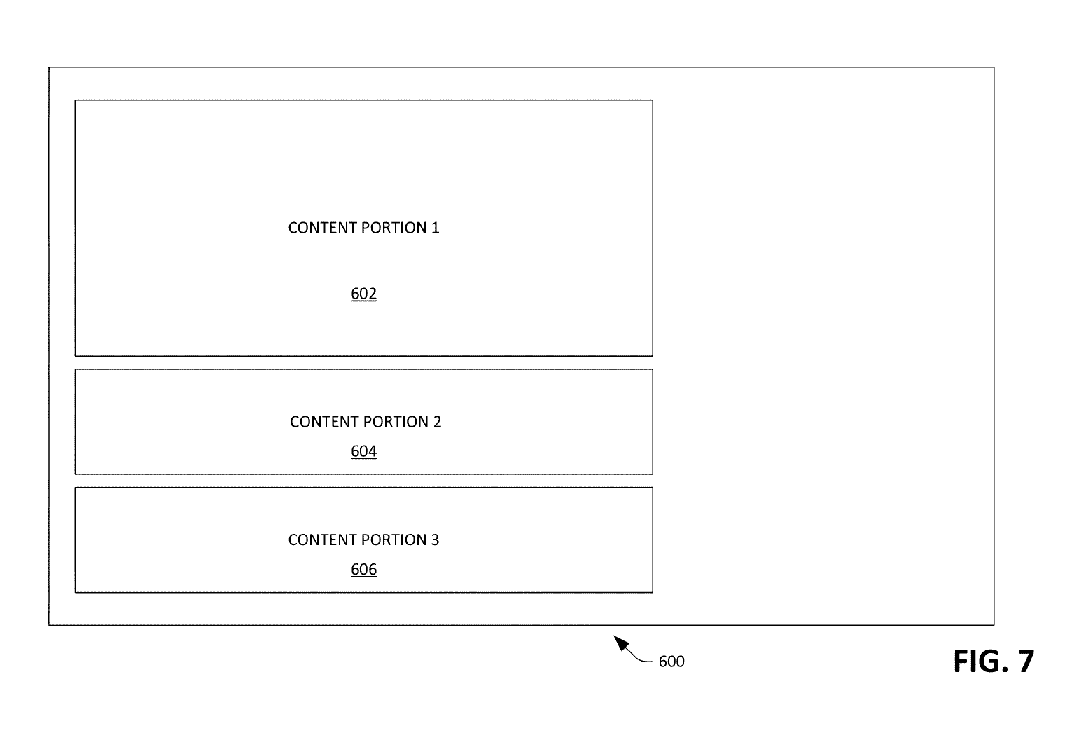

Now turning to FIG. 7, the page 600 as presented on the display 106 of the client computing device 102 is illustrated, wherein the user 104 has won the auctions for the respective advertisement positions 608-612. In the example shown in FIG. 7, the user 104 has approved blank spaces as content that is to populate the advertisement positions 608-612, wherein the blank spaces have a color that matches the background color of the page 600. Alternatively, while not shown, the user 104 can approve other types of content for inclusion in the advertisement positions 608-612, such as images of the family of the user 104, favorite scenic images of the user 104, etc. As the layout of the page 600 is fixed, however, prevention of advertisements from being included in the advertisement positions 608-612 does not allow for more of the content 111 to be presented on the page 600.

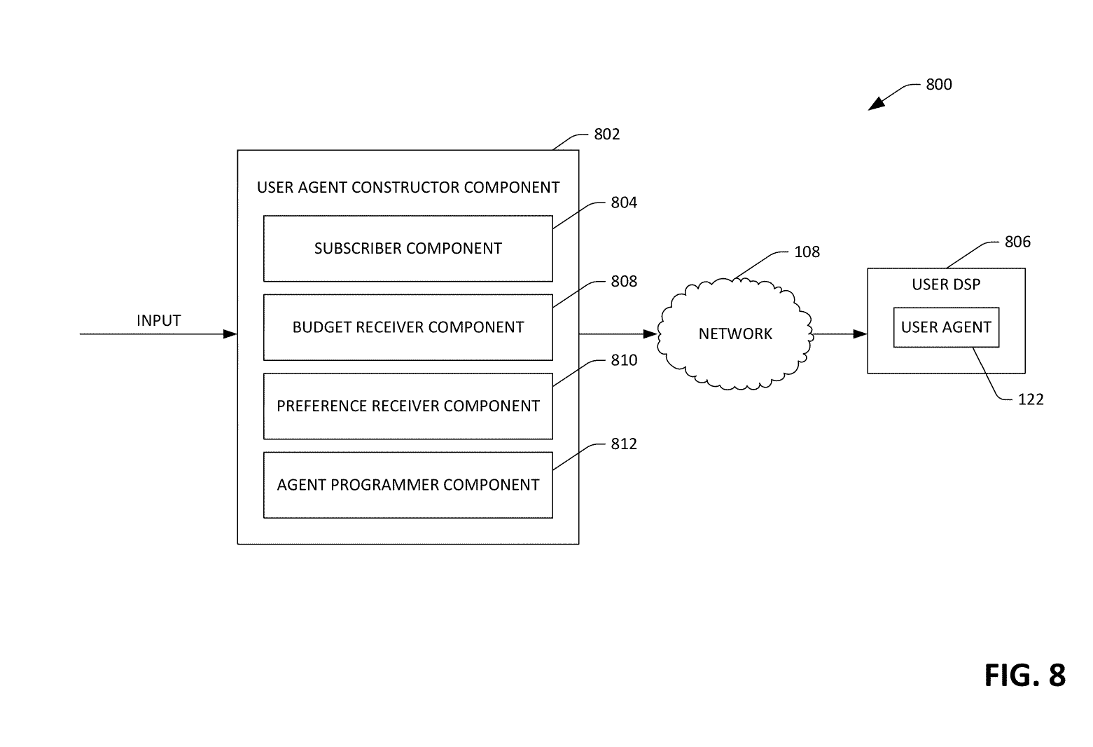

Now referring to FIG. 8, an exemplary system 800 that facilitates constructing the user agent 122 is illustrated. The system 800 includes a user agent constructor component 802 that receives an indication that the user 104 wishes to construct the user agent 122. For example, the user 104 can install an add-in (plug-in) to a web browser installed on the client computing device 102, wherein installment of the add-in indicates to the user agent constructor component 802 that the user 104 wishes to construct the user agent 122. The user agent constructor component 802 includes a subscriber component 804 that communicates with a demand side platform 806 by way of the network 108 to set up an account with the DSP on behalf of the user 104. Subscription with the DSP 806 allows the user 104 to participate in auctions run by several different advertisement exchanges without forcing the user 104 to set up respective accounts for each of the ad exchanges. Responsive to the subscriber component 804 generating an account with the DSP 806 on behalf of the user 104, the domain coverage of the DSP 806 can be received. The domain coverage of the DSP 806 is indicative of all of the different web domains with respect to which the DSP 806 is configured to receive bid solicitations from advertisement exchanges. Additionally, while not shown, the user agent constructor component 802 can receive browsing history from the add-in responsive to the add-in being installed in the web browser. The user agent constructor component 802 can merge the domain coverage of the DSP 806 with historical domains visited by the user 104 (as evidenced in the browser history), thereby allowing most frequently visited domains that are also covered by the DSP 806 to be surfaced to the user 104.

The user agent constructor component 802 can cause a GUI to be presented on the display 106 of the client computing device 102 to the user 104, wherein the GUI is configured to receive information from the user 104 pertaining to prevention of display of advertisements. For example, the user agent constructor component 802 can include a budget receiver component 808 that receives a budget specified by the user 104 with respect to bids to be submitted on behalf of the user 104. For instance, the budget receiver component 808 can receive an indication of a monetary value and some period of time over which the monetary value can be used to prevent advertisements from being presented to the user 104 (e.g., $20 for one year, $3 per month, etc.). Accordingly, when created, the user agent 122 is linked with an account of the user 104.

The user agent constructor component 802 can further include a preference receiver component 810 that can receive an indication of preferences of the user 104 with respect to advertisements desirably prevented from being displayed on the display 106 of the client computing device 102. For example, the user 104 can specify one or more categories, where the user 104 wishes for the user agent 122 to set forth bids for advertisement positions when the user 104 is viewing a page of one of the specified categories. Exemplary categories include social networking websites, news websites, e-mail, blog websites, weather websites or the like. More granularly, the preference receiver compound 810 can receive identifications of particular domains, categories, or specific web pages, wherein the user 104 wishes that the user agent 122 set forth bids on behalf of the user 104 for advertisement positions when specific web pages, web pages belonging to the particular domains, and/or web pages belonging to particular categories are to be displayed on the display 106 of the client computing device 102.

The user agent constructor component 802 can also include an agent programmer component 812 that programs the user agent 122 based upon, for example, the domain coverage of the DSP 806, the budget information of the user 104 received by the budget receiver component 808, any user preferences received by the preference receiver component 810, and known bidding trends of other advertisers. In an example, the resultant user agent 122 can bid “intelligently” by considering varying factors when determining which auctions to participate in, when determining values of bids, etc., wherein exemplary factors include remaining money in the budget, remaining time left in the budget period, browsing history of the user 104, preferences specified by the user 104, etc. In other examples, the user 104 may fix the behavior of the user agent 122 in certain circumstances, by causing the user agent 122 to submit particular bid amounts for all pages, for pages identified by the user 104, etc. The user agent 122 can be associated with the account of the user 104 in the DSP 806, such that when bids are solicited by an advertisement exchange, the DSP 806 can respond with a bid set forth by the user agent 122.

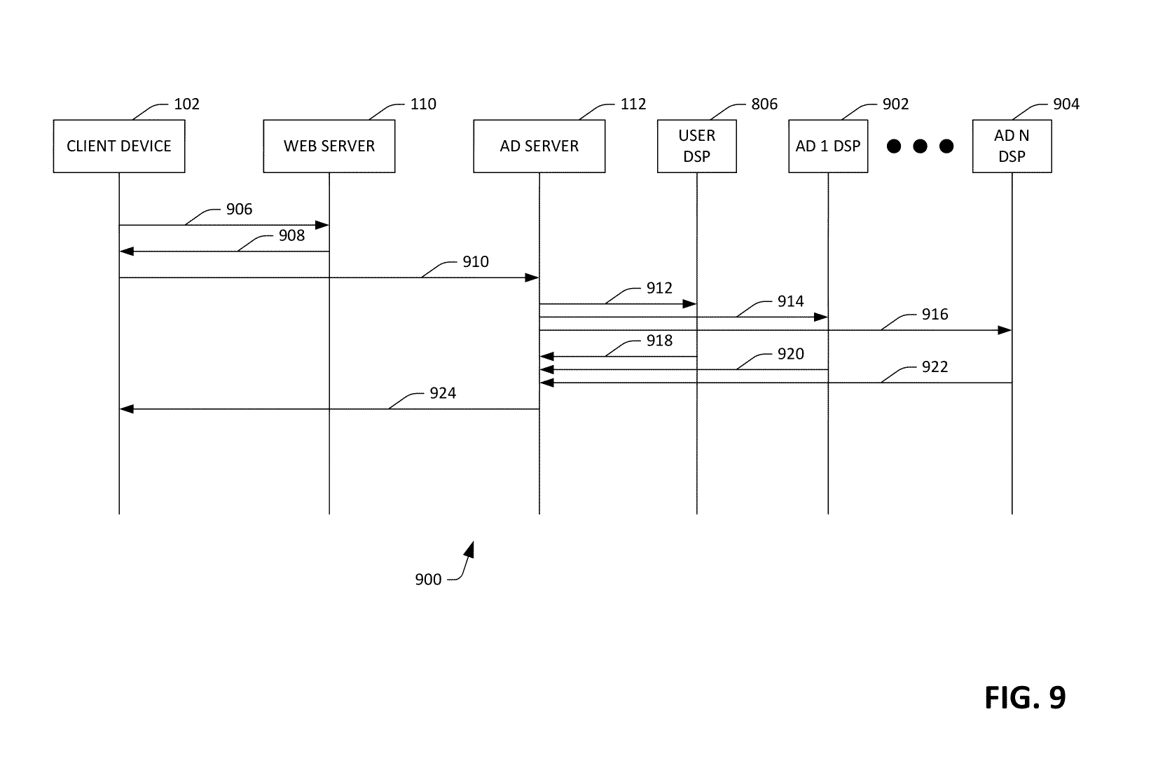

With reference now to FIG. 9, an exemplary communications diagram 900 illustrating communications between the client computing device 102, the web server 110, the ad server 112, the user DSP 806, and a plurality of DSP accounts of advertisers (e.g., ad DSPs 902-904) that respectively correspond to the ad agents 118-120 shown in FIG. 1 is presented. At 906, an application (e.g., a web browser) executing on the client computing device 102 transmits a request to the web server 110 for the content 111 (e.g., a web page). Responsive to receiving the request for the content 111, the web server 110 transmits, at 908, the content 111 and an advertisement redirect to the client computing device 102, wherein the advertisement redirect identifies the ad server 112. At 910, responsive to receiving the advertisement redirect, the client computing device 102 transmits an indication to the ad server 112 that the content 111 on the web server 110 has been requested by the client computing device 102. Further, at 910, responsive to receiving the advertisement redirect, the client computing device 102 may also transmit a cookie to the ad server 112, which can include information about the browsing history of the user 104, demographic data about the user 104, or the like.

At 912, 914, and 916, the ad server 112 transmits respective solicitations for bids to the user DSP 806, and the ad DSPs 902-904. For example, at 912-916, the ad server 112 can transmit the cookie (received from the client computing device 102 at 910) to the DSPs 806 and 902-904 (or data included in such cookie). The user DSP 806, responsive to receiving the solicitation for the bid at 912, provides the bid solicitation and data corresponding thereto to the user agent 122, which formulates a bid for the advertisement position on the page to be displayed on the display 106 of the client computing device 102. At 918, the user DSP 806 transmits the bid (with the bid value specified by the user agent 122) to the ad server 112. The DSPs 902-904 act in a similar manner, transmitting bids with respective bid values on behalf of advertisers to the ad server at 922 and 924, respectively. The ad server 812, responsive to receiving the bids at 918-922, identifies a winner of the auction based upon bid values of the bid, wherein the bidder who submitted the bid with the highest bid value is deemed by the ad server 112 as being the winner of the advertisement position. At 924, the ad server 112 transmits a redirect specified by the DSP of the auction winner to the client computing device 102. When, for example, the user 104 is the winner of the auction, the redirect specified by the user DSP 806 can direct the client computing device 102 to a one pixel image. The client computing device 102, responsive to receiving the redirect at 924, renders the page based upon the content received at 908 and the content corresponding to the redirect received at 924.

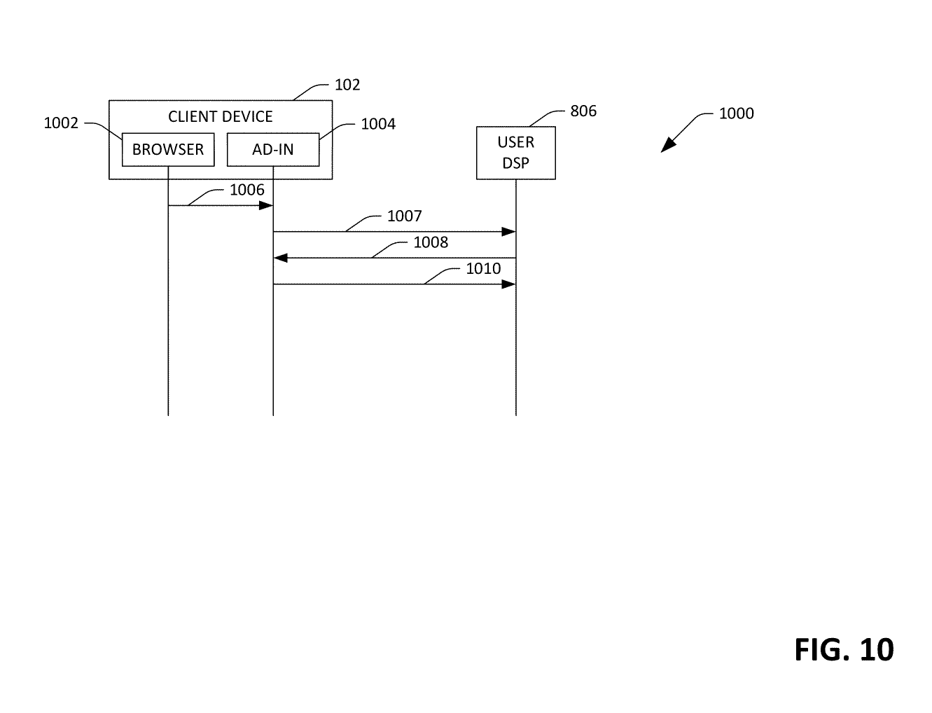

With reference now to FIG. 10, another exemplary communications diagram 1000 illustrating communications between the client computing device 102 and the user DSP 806 is illustrated. The client computing device 102, in an example, has a web browser 1002 installed thereon, and further has a browser add-in installed thereon. It is to be understood that the client computing device 102 may have other applications installed thereon. When the user 104 causes the client computing device 102 to install the add-in 1004, at 1006, the browser 1002 passes browsing history to the add-in 1004. The ad-in 1004, responsive to receiving the browsing history, transmits a request to the user DSP 806 at 1007 for the domain coverage of the user DSP 806. Optionally, while not shown, the add-in can initiate a subscription process, where the user 104 creates an account with the user DSP 806 responsive to the add-in being installed on the client computing device 102. At 1008, the user DSP 806 transmits its domain coverage to the add-in 1004. The add-in 1004 can merge the history with the domain coverage of the user DSP 806 and can present graphical information to the user that allows the user 104 to set bids for particular domains and/or categories. This can result in the formation of a DSP cookie, which can identify domains/categories of interest to the user 104, and such cookie can be transmitted to the user DSP 806 at 1010. Additionally, bid values corresponding to domains and/or categories identified in the DSP cookie can be transmitted to the user DSP 806. In such an example, the user DSP 806 can submit bids based upon the contents of the DSP cookie (and the DSP can acts as the user bidding agent 122).

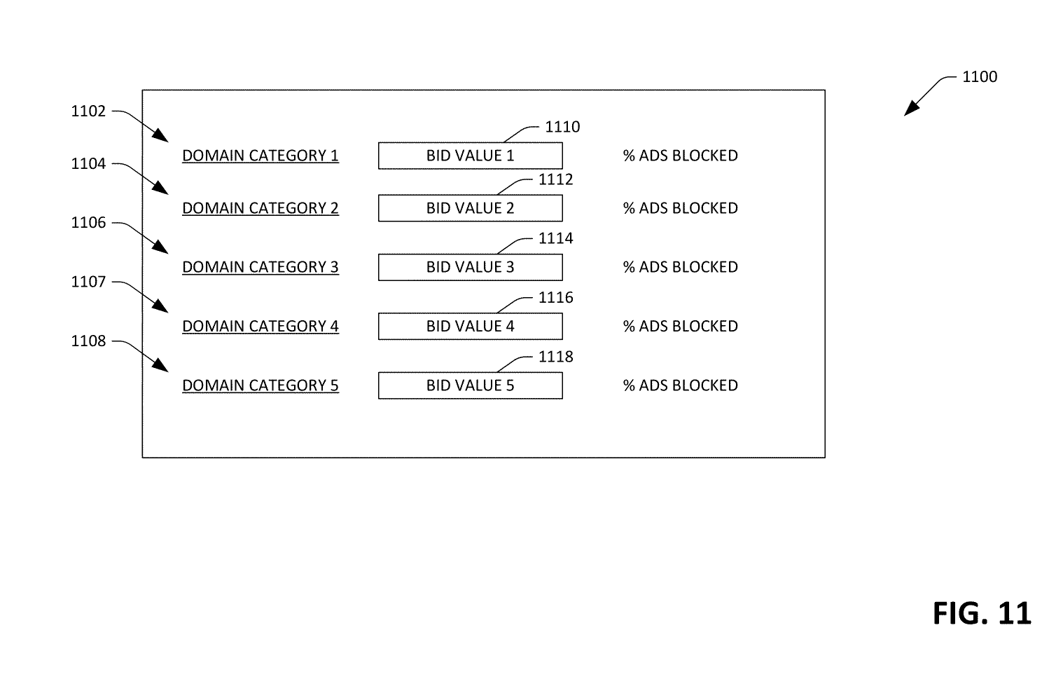

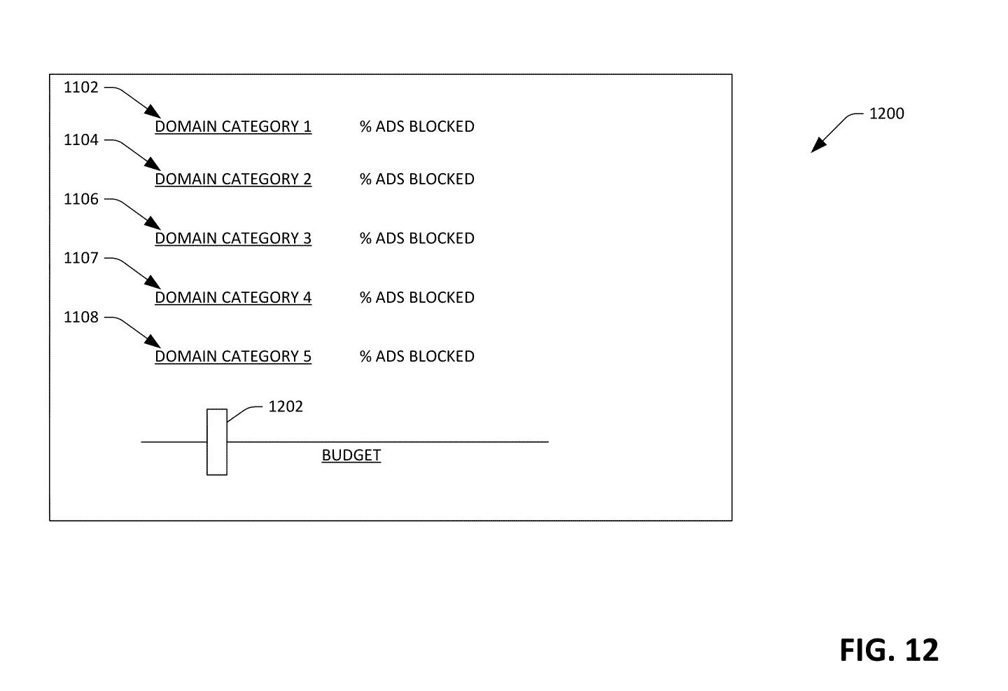

FIGS. 11 and 12 illustrate exemplary GUIs that can be employed in connection with user bidding on advertisement positions in auctions for the advertisement positions. With reference solely to FIG. 11, an exemplary GUI 1100 is depicted. The GUI 1100 illustrates a plurality of domain categories identified as being of interest to the user 104 (e.g., based upon browsing history of the user 104 and/or explicit input from the user 104). The domain categories 1102-1108 can generally identify categories pertaining to websites of interest to the user 104. Such categories can be identified, for instance, by a general purpose search engine when indexing web pages. In another example, a category can be a list of user-specified domains that may not necessarily correspond to a particular theme. Pursuant to an example, the first domain category 1102 may be “social networking”, the second domain category 1104 may be “news”, the third domain category 1106 may be “email”, and so on. The GUI 1100 includes a plurality of data entry fields 1110-1118, wherein the data entry fields 1110-1118 are configured to receive bid values from the user 104 for the respective categories 1102-1108. For example, a bid value entered into the first data entry field 1110 can identify an amount to be bid for each advertisement position on pages categorized as belonging to the first domain category 1102. Similarly, a bid value entered into the second data entry field 1112 can be an amount that is to be bid for advertisement positions on pages belonging to the second domain category 1104. Accordingly, by way of the data entry fields 1110-1118, the user 104 can enter bid values that are to be used when the user participates in auctions for advertisement positions. Alternatively, as noted above, for at least some categories, intelligent bidding can be enabled through use of a bidding agent, as described above.

The GUI 1100 may also display information associated with the bid values and domain categories. For example, as shown, the information can include estimates of a percentage of advertisements that will effectively be “blocked” using the bid values for the respective domain categories. For example, given the bid value entered in the first data entry field 1110, the information can indicate that 80% of advertisements will be blocked. These estimates can be computed based upon historic bidder activity with respect to pages belonging to the domain categories. In an example, web pages belonging to the first domain category 1102 may command higher prices for advertisement positions than web pages belonging to the second domain category 1104. Other information may also be presented in the GUI 1100, such as an expected amount of total money to be spent when blocking ads over the course of some predefined time period using the bid values set forth in the respective data entry fields 1110-1118, a percentage of the budget that is expected to be spent on each category, etc. For example, when the user sets a bid value in the first data entry field 1110, the associated information can inform the user 104 of a percentage of advertisements that will be blocked when such bid value is used when bidding on advertisement positions for web pages belonging to the first domain category 1102, and can further indicate (based on user browsing history) a total amount of money that will be spent for some predefined period of time (e.g., one year). Therefore, the user 104 can set bidding policies relatively quickly and can make informed decisions when setting such bidding policies.

Now referring to FIG. 12, another GUI 1200 that may be presented to the user 104 to assist the user in constructing the user agent 122 is illustrated. In the exemplary GUI 1200, the domain categories 1102-1110 are presented. The GUI 1200 also includes a slide bar 1202 that allows the user 104 to quickly set a budget (e.g., $20 per year). As the user 104 moves the slide bar 1202, the associated information shown with the domain categories 1102-1110 can change. The user 104 may optionally weight domain categories and/or particular domains, such that one domain category or domain is provided a relatively higher weight than another domain category or domain (e.g., indicating that the user 104 is more interested in having advertisements blocked on pages of a first domain than having advertisements blocked on pages of a second domain). Based upon the budget and other optional information provided by the user 104 by way of the GUI 1200, the user agent 122 can be constructed to intelligently set forth bids on behalf of the user 104, while staying within the specified budget.

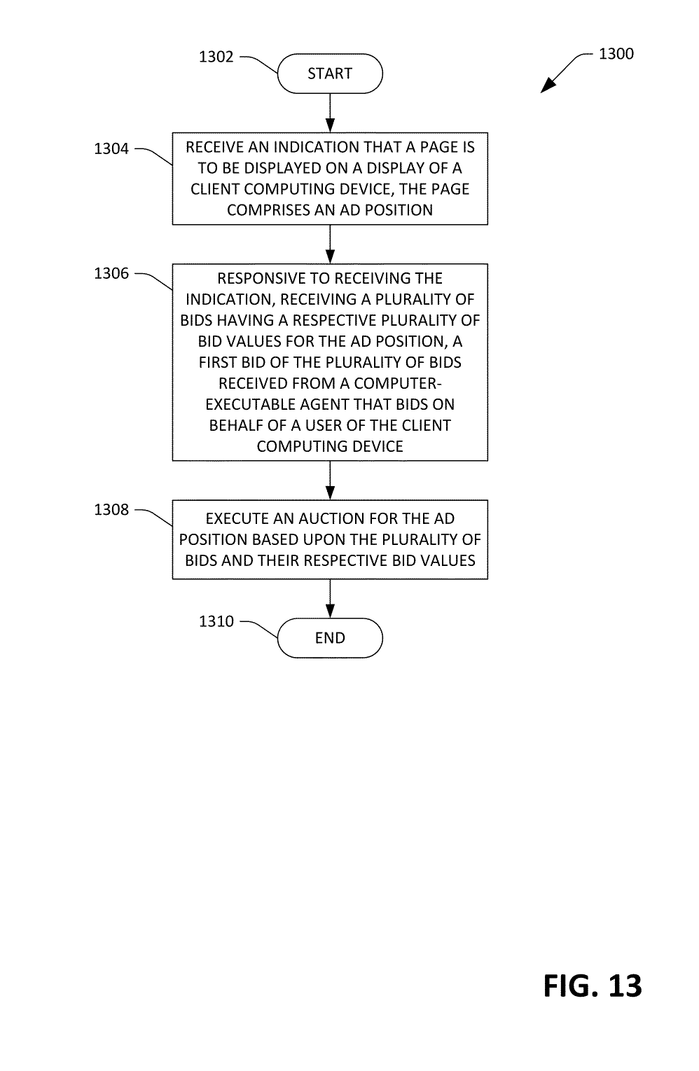

FIGS. 13-15 illustrate exemplary methodologies relating to prevention of display of advertisements by way of user-participation in auctions for advertisement positions. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring to FIG. 13, an exemplary methodology 1300 that facilitates executing an auction for an advertisement position on a page is illustrated. The methodology 1300 starts at 1302, and at 1304 an indication is received that a page is to be displayed on a display of a client computing device, wherein the page comprises an advertisement position that is configured to be populated by an advertisement. At 1306, responsive to receiving the indication, a plurality of bids are received for the advertisement position, wherein the plurality of bids have a respective plurality of values. The plurality of bids include a first bid that is submitted on behalf of a user of the client computing device. For instance, the first bid can be received from a DSP that has an account for the user.

At 1308, a real-time auction is executed for the advertisement position based upon the plurality of bids and their respective bid values. A bidder that submits the bid with the highest bid value is the winner of the real-time auction, and content identified by the winner is displayed on the page at the client computing device. The methodology for 1300 completes at 1310.

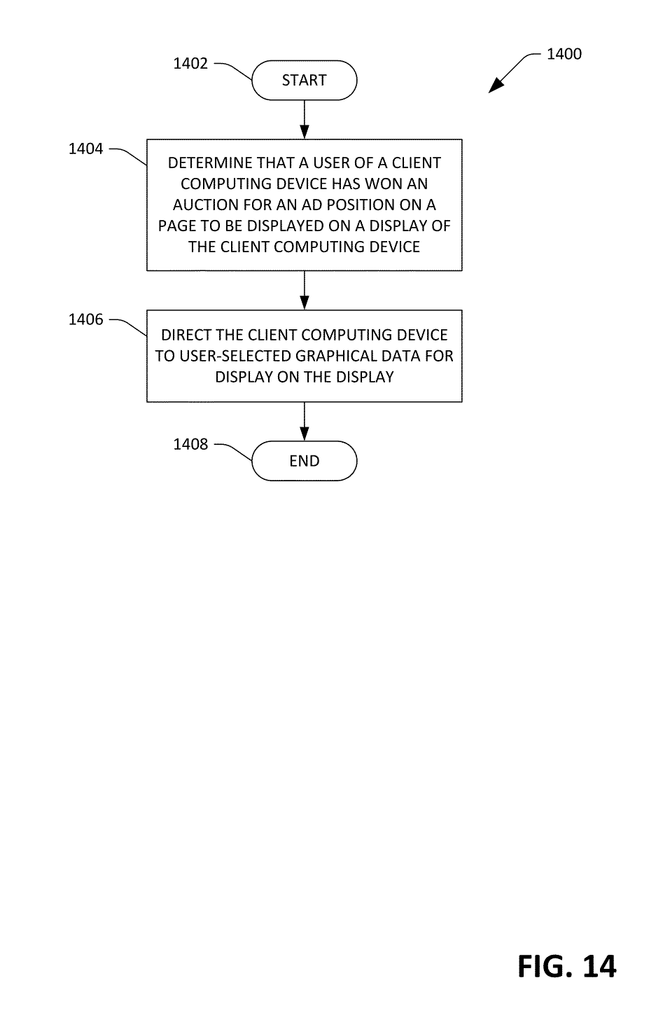

Now turning to FIG. 14, an exemplary methodology 1400 that facilitates display of user-approved content in an advertisement position on a page is illustrated. The methodology 1400 starts at 1402, and at 1404, it is determined that a user of a client computing device has won an auction for an advertisement position on a page that has been requested to be displayed on a display of the client computing device. At 1406, the client computing device is directed to user-specified graphical data for display on the display in the advertisement position on the page. The methodology 1400 completes at 1408.

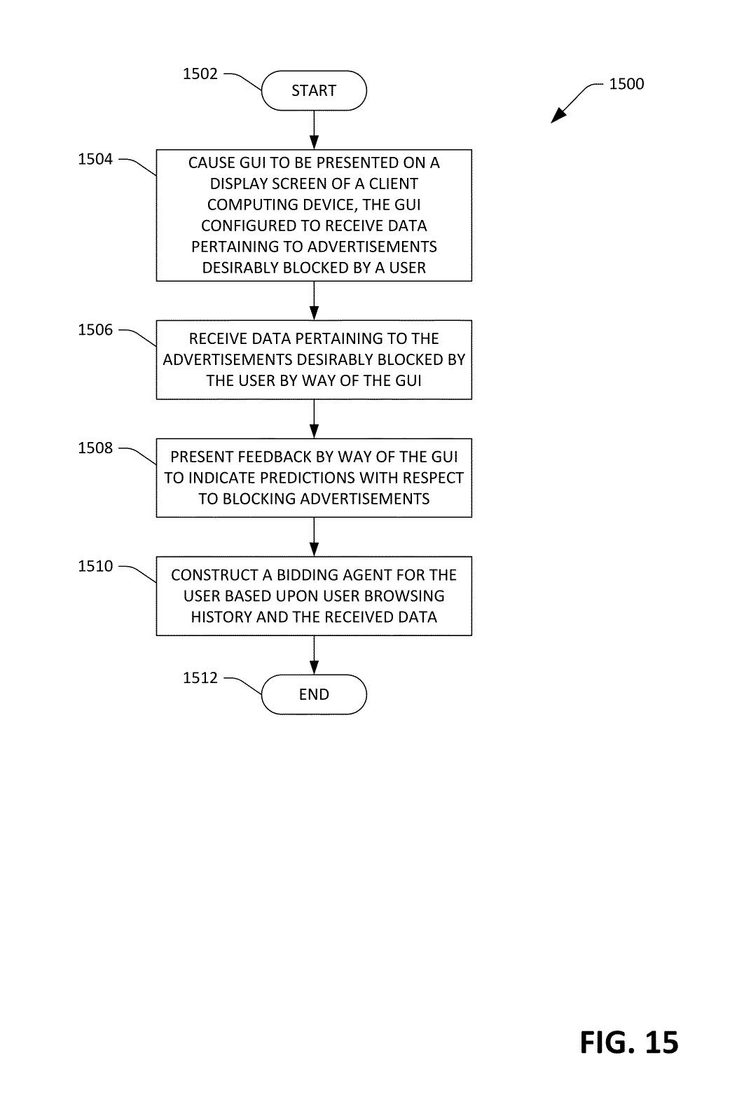

Now referring to FIG. 15, an exemplary methodology 1500 for constructing a user bidding agent is illustrated. The methodology 1500 starts at 1502, and at 1504, a GUI is caused to be presented on a display of a client computing device, wherein the GUI is configured to receive data pertaining to advertisements that are desirably blocked by a user. Such data may include budgetary information, data identifying domains or page categories upon which advertisements are desirably blocked, etc.

At 1506, data pertaining to the advertisements desirably blocked is received by way of the GUI. For example, the user can enter data into data entry fields, move slide bars, select checkboxes, etc. to provide such information. At 1508, feedback is presented to the user by way of the GUI to indicate estimates with respect to blocking advertisements. For example, the feedback can indicate that based upon the data received a 1506, some percentage of all advertisements that otherwise would be presented to the user will be blocked. The user can optionally modify the data received at 1506 based upon the feedback presented at 1508. At 1510, a bidding agent is constructed for the user based upon, for example, the data received at 1506, browsing history of the user, known (observed) bidding practices of advertisers, etc. The methodology 1500 completes at 1512.

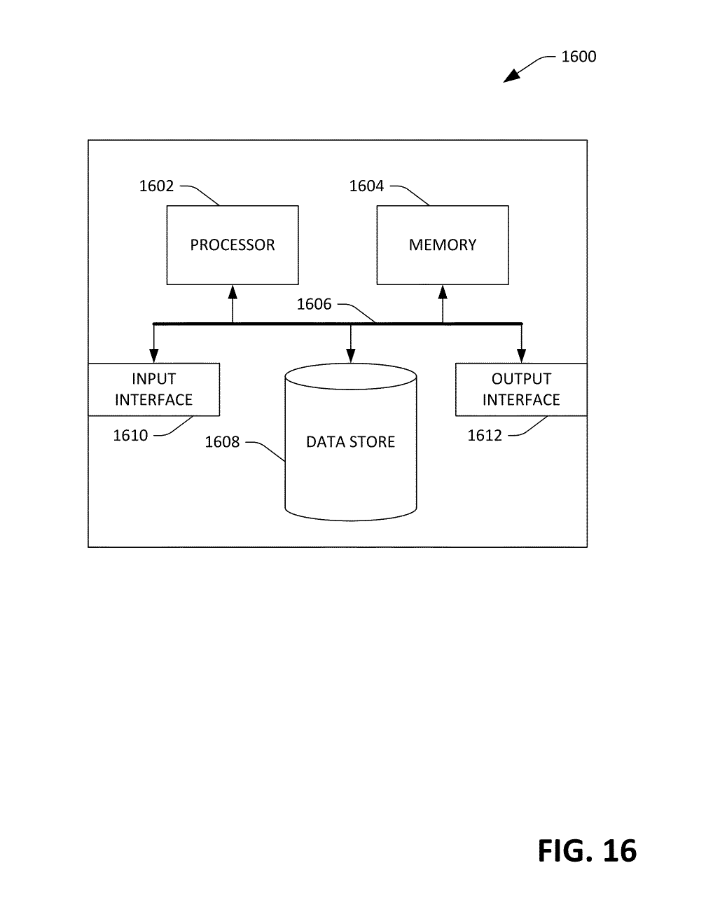

Referring now to FIG. 16, a high-level illustration of an exemplary computing device 1600 that can be used in accordance with the systems and methodologies disclosed herein is illustrated. For instance, the computing device 1600 may be used in a system that executes auctions for advertisement positions on pages requested by client computing devices. By way of another example, the computing device 1600 can be used in a system that is configured to construct a user bidding agent that submits bids on behalf of a user. The computing device 1600 includes at least one processor 1602 that executes instructions that are stored in a memory 1604. The instructions may be, for instance, instructions for implementing functionality described as being carried out by one or more components discussed above or instructions for implementing one or more of the methods described above. The processor 1602 may access the memory 1604 by way of a system bus 1606. In addition to storing executable instructions, the memory 1604 may also store bid values, advertisements, etc.

The computing device 1600 additionally includes a data store 1608 that is accessible by the processor 1602 by way of the system bus 1606. The data store 1608 may include executable instructions, advertisements, bid values, browsing history, etc. The computing device 1600 also includes an input interface 1610 that allows external devices to communicate with the computing device 1600. For instance, the input interface 1610 may be used to receive instructions from an external computer device, from a user, etc. The computing device 1600 also includes an output interface 1612 that interfaces the computing device 1600 with one or more external devices. For example, the computing device 1600 may display text, images, etc. by way of the output interface 1612.

It is contemplated that the external devices that communicate with the computing device 1600 via the input interface 1610 and the output interface 1612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1600 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1600 may be a distributed system. Thus, for instance, several devices may be in communication by way of a network connection and may collectively perform tasks described as being performed by the computing device 1600.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method executed at an ad server, the method comprising:
receiving an indication that a page is to be displayed on a display of a client computing device, the page comprising an advertisement position that is configured to be populated by an advertisement;
responsive to receiving the indication, receiving a plurality of bids for the advertisement position, the plurality of bids having a respective plurality of bid values, the plurality of bids comprising a first bid received from a first computer-executable agent that is configured to submit the first bid on behalf of a user of the client computing device; and
executing an auction for the advertisement position based upon the plurality of bid values.

2. The method of claim 1, wherein executing the auction comprises:
identifying that the user has won the auction for the advertisement position based upon a bid value of the first bid relative to other bid values in the plurality of bid values; and
responsive to identifying that the user has won the auction for the advertisement position, causing graphical content specified by the user to be presented in the advertisement position when the page is displayed on the display of the client computing device.

3. The method of claim 2, wherein the graphical content is a one by one pixel window.

4. The method of claim 2, wherein the graphical content comprises an image specified by the user.

5. The method of claim 2, wherein executing the auction further comprises:
responsive to identifying that the user has won the auction for the advertisement position, assessing a charge to an account of the user, the charge based upon a second bid for the advertisement position submitted by a second computer-executable agent that submitted the second bid on behalf of an advertiser.

6. The method of claim 1, wherein executing the auction comprises:
identifying that an advertiser has won the auction for the advertisement position based upon a bid value of a bid submitted by the advertiser; and
responsive to identifying that the advertiser has won the auction for the advertisement position, causing an advertisement of the advertiser to be presented in the advertisement position when the page is displayed on the display of the client computing device.

7. The method of claim 6, wherein executing the auction further comprises:
responsive to identifying that the advertiser has won the auction for the advertisement position, assessing a charge to an account of the advertiser, the charge based upon the first bid.

8. The method of claim 1, wherein the page is a web page that is rendered in a web browser executing on the client computing device.

9. The method of claim 1, wherein the page is to be rendered in an application executing on the client computing device, the application being other than a web browser.

10. The method of claim 1, wherein the computer-executable agent executes in a demand-side platform with which the user has an account.

11. An advertisement server, comprising:
a receiver component that receives an indication that a page is to be displayed on a display of a client computing device, the page comprising an advertisement position that is configured to be populated by an advertisement;
an auction executor component that, responsive to the receiver component receiving the indication that the page is to be displayed on the display, executions an auction for the advertisement position, wherein in connection with executing the auction, the auction executor component:
obtains a plurality of bids for the advertisement position, the plurality of bids having a respective plurality of bid values, a first bid in the plurality of bids obtained from a demand-side platform (DSP) account of a user of the client computing device;
identifies a winner of the auction based upon the plurality of bid values; and
causes graphical content to be displayed in the advertisement position on the page, the graphical content specified by the winner of the auction.

12. The advertisement server of claim 11, wherein the user is the winner of the auction, the graphical content displayed in the advertisement position is approved by the user.

13. The advertisement server of claim 12, wherein the graphical content approved by the user is a blank space having a color that matches a background color of the page.

14. The advertisement server of claim 12, wherein the page is configured to be dynamically laid out at the client computing device, the graphical content approved by the user is a one pixel by one pixel window.

15. The advertisement server of claim 12, wherein the graphical content approved by the user is an image identified by the user.

16. The advertisement server of claim 11, other bids in the plurality of bids received from respective DSP accounts of advertisers.

17. The advertisement server of claim 16, the winner of the auction is an advertiser from amongst the advertisers, the graphical content displayed in the advertisement position on the page is an advertisement of the advertiser.

18. The advertisement server of claim 11, wherein the user is the winner of the auction, the auction executor component is configured to assess a charge to an account of the user responsive to identifying that the user is the winner of the auction, the charge based upon a bid value of another bid set forth by an advertiser.

19. The advertisement server of claim 11, the page being a web page, the web page being one of a blog web page, a web page of a social networking website, or a web page of a news website.

20. A computer-readable storage medium comprising instructions that, when executed by a processor, cause the processor to perform acts comprising:
receiving an indication that a web page is being loaded by a web browser executing on a client computing device of a user, the web page comprising an advertisement position;
responsive to receiving the indication that the web page is being loaded by the web browser, executing an auction for the advertisement position, wherein executing the auction for the advertisement position comprises:
receiving a plurality of bids having a respective plurality of bid values, a first bid in the plurality of bids received from a demand-side platform (DSP) account of the user;
determining that the user is the winner of the auction based upon the plurality of bid values, a bid value of the first bid being a highest bid value from amongst the plurality of bid values;
responsive to determining that the user is the winner of the auction, transmitting data that identifies a location of graphical content approved by the user for display in the advertisement position on the web page; and
responsive to determining that the user is the winner of the auction, assessing a charge to an account of the user, an amount of the charge based upon at least one other bid value in the plurality of bid values.
